(19) United States
(12) Patent Application Publication
(10) Pub. No.: US 2005/0105976 A1
(43) Pub. Date: May 19, 2005

(54) Inverted drill press

(76) Inventor: Kim C. Groomes, Hartland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/715,318

(22) Filed: Nov. 17, 2003

(51) Int. Cl. B23B 47/18; B23B 47/00

(52) U.S. Cl. 408/1 R; 408/135

(57) ABSTRACT

A drill press assembly has a drill chuck mounted to an extendable stand. The drill chuck is inverted to receive a drill bit oriented to drill in an upward direction. The stand extends between a first height and a second height. The second height is higher than the first height relative to ground. An actuator allows the stand to apply an upward drilling force from ground to the drill chuck at any selectable height.

### BACKGROUND OF THE INVENTION

This invention relates to a drill press.

From time to time, maintenance and service of an aircraft requires that bolts underneath a wing of an aircraft be replaced. In the past, a service technician would use a hand drill to drill out each of these bolts from a position underneath the aircraft wing. Given the large number of bolts on the wing of the aircraft, this task is both time consuming and tiring for the service technician. In addition, hand drilling exposes the service technician to drilling chips that fall from the aircraft wing. These chips are hot and may cause the service technician additional discomfort.

It is impractical to use a standard drill press to remove these structural bolts from the aircraft because of the size and height of the aircraft wing. Drill presses exist that use magnetic feet to attach themselves to a work piece to be drilled in an inverted fashion. However, these drill presses only work on surfaces that are receptive to magnets and do not work on an aluminum aircraft wing. In addition, these drill presses provide insufficient drilling force to drill out a structural bolt of an aircraft and require a fair amount of time to move from drilling location to location.

A need therefore exists for a drill press assembly that overcomes the deficiencies of existing drill presses and permits the inverted drilling of a work piece in an efficient and cost effective manner.

### SUMMARY OF THE INVENTION

The present invention comprises a drill press assembly, having a drill chuck, a stand, and a press. In contrast to conventional drilling devices, the stand of the inventive drill press allows elevation of an inverted drill chuck between a first height and a second height relative to ground. From an elevated position, the drill press may apply an upward drilling force from ground to a work piece. Unlike the prior art, the inventive drill press may accordingly be used with nonferrous work pieces. In addition, the drill press creates a greater drilling force because it is supported from ground.

The stand has a first tube and a second tube. The first tube telescopes relative to the second tube, thereby permitting the stand to support the drill chuck from ground at a variety of heights. A press may create the upward drilling force for the drill chuck and drill bit following their elevation. The press may be a rack and a pinion. The rack may be attached to one tube and the pinion attached to the other. The first tube may be received in the second tube. In addition, the second tube may have a foot that pivots relative to the second tube so that the stand may be supported at various angles relative to the ground. The design is thus simple and lightweight, permitting the drill press to be moved from location to location quickly.

The drill chuck may be rotated by a drive mechanism. The drive mechanism may be contained in the drill press assembly. The drive mechanism is preferably a pneumatic drive, which allows the assembly to be light as well as powerful.

With the inventive assembly, a drill bit in the drill chuck may be supported from ground beneath a work piece. Because the chuck is inverted, the drill bit may be oriented in the drill chuck to drill in an upward direction. The press allows the drill bit to be elevated through the stand from a lower elevation to a higher elevation relative to ground to create an upward drilling force. The drill bit is then rotated as the drill bit is elevated.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a side profile of the inventive drill press assembly in a retracted state.

FIG. 2 illustrates the inventive drill press assembly of FIG. 1 in an extended state.

FIG. 3 illustrates a view of the actuator of the inventive drill press assembly of FIGS. 1-2.

FIG. 4A illustrates an exposed view of the actuator of FIG. 3 in a position allowing extension of the assembly.

FIG. 4B illustrates an exposed view of the actuator of FIG. 3 in a position to create an upward pressing force.

FIG. 5 illustrates a close-up view of a drill drive mechanism and drill chuck of the inventive drill press assembly of FIGS. 1-4.

FIG. 6 illustrates an end fitting for the drill drive mechanism of FIG. 5.

FIG. 7 illustrates a side profile of the pivotable foot of the inventive drill press of the foregoing figures.

FIG. 8 illustrates drill press assembly pivoting relationship to ground.

### DETAILED DESCRIPTION OF THE PREFERRED EMBODIMENT

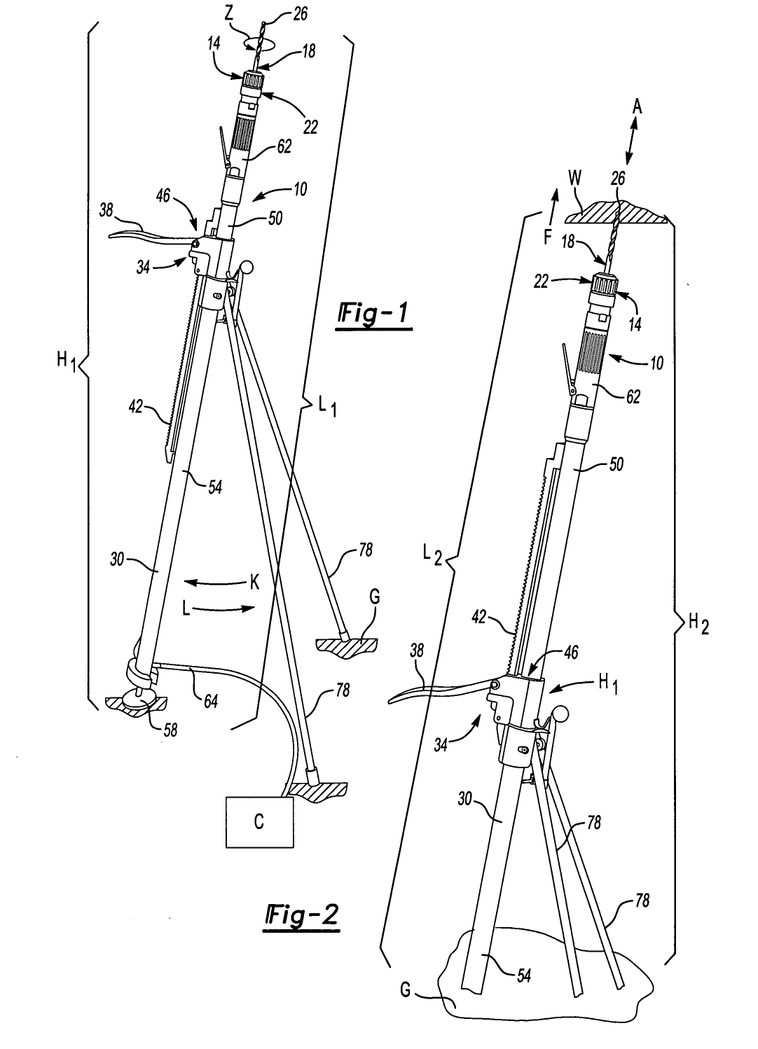

FIG. 1 illustrates inventive drill press assembly 10. Like conventional drill presses, drill press assembly 10 has drill chuck 14, which has opening 18 elevated above bottom 22 (located in interior of drill chuck 14). Opening 18 receives drill bit 26 and is supported within drill chuck 14 by bottom 22. Drill chuck 14 is inverted (opening 18 facing upward to receive drill bit 26 but is otherwise of conventional design). Drill chuck 14 is rotatable along the direction of arrow Z to rotate drill bit 26 in the same direction through drill drive mechanism 62. Drill drive mechanism 26 may also rotate drill chuck 14 and drill bit 26 in the opposite direction. Preferably, drill drive mechanism 62 is a pneumatic drive powered by compressor C as known through compressor hose 64. These features of the inventive drill press assembly 10 are well known.

In contrast to conventional designs, inventive drill press 10 uses extendable stand 30, a brace, that allows elevation of inverted drill chuck 14 and drill bit 26 relative to ground G. Extendable stand 30 has first member 50, a tube, and second member 54, also a tube. First member 50 is slidably received within second member 54 so that first member 50 may telescope relative to second member 54. Stand 30 has a retracted length of L₁ as shown in FIG. 1 and telescopes to an extended length of L₂, a length greater than L₁, as shown in FIG. 2. Accordingly, stand 30 may be elevated from height H₁ shown in FIG. 2 to height H₂, a height higher than H₁, as shown in FIG. 2. In this way, drill press assembly 10 may provide support from ground G to work piece W, say an aircraft wing, above stand 30.

Specifically, drill bit 26 is supported from ground G by stand 30. Drill chuck 14 is inverted to allow drill bit 26 to be oriented for drilling in an upward direction along axis A. By telescoping standing from length L₁ to length L₂, drill bit 26 may be elevated from a selected height between height H₁ to height H₂ along axis A. Drill bit 26 rotates along the direction of arrow Z about axis A. This technique thereby permits the drilling out of bolts from work piece W, say an aircraft wing, from underneath work piece W.

In addition, drill press assembly 10 has a press, actuator 34, to provide an upward drilling force from ground G to elevate drill chuck 14 and drill bit 26 further from the selected height along axis A. Drill press force F is shown in FIG. 2 extending along the same axis. Accordingly, drill press assembly 10 not only supports drill chuck 14 and drill bit 26 at various heights, but also provides an upward drilling force F.

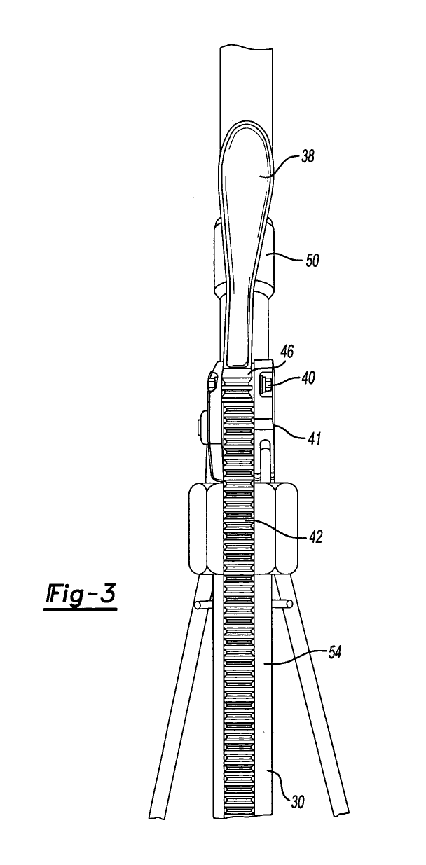

The creation of this upward drilling force will now be explained. As shown in FIGS. 2 and 3, actuator 34 comprises lever 38, rack 42, and pinion 46. Rack 42 is directly mounted to first member 50. Both pinion 46 and lever 38 are pivotally mounted to second member 54 through pin 40 and bracket 41, which is directly attached to second member 54. Pinion 46 is formed as a part of lever 38.

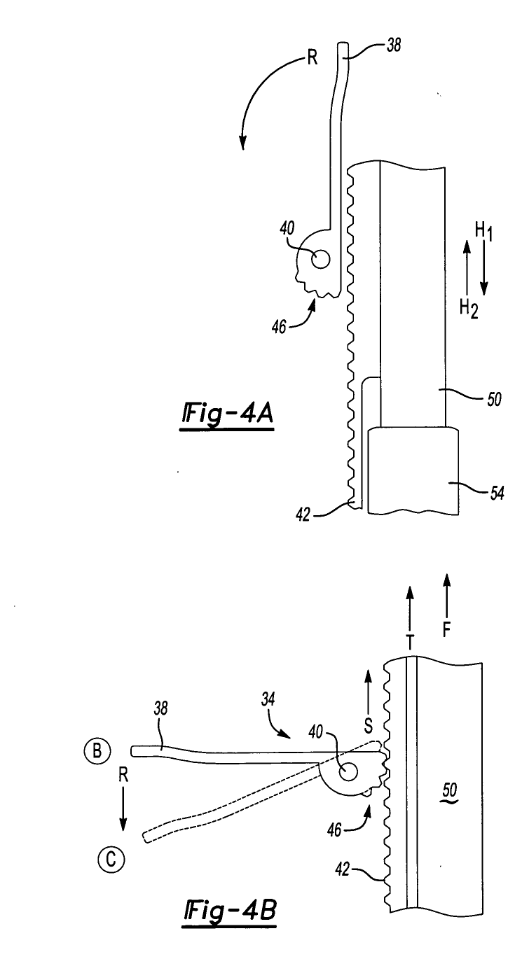

Prior to the creation of upward drilling force F₁, drill chuck 14 is elevated to a desired height by telescoping stand 30 to a height between H₁ and H₂. Stand 30 is free to move to such a desired position by placing lever 38 in position A as shown in FIG. 3 and FIG. 4A. In position A, pinion 46 is not engaged to rack 42. Accordingly, first member 50 is free to be extended relative to second member 54.

Following elevation of drill chuck 14, lever 38 is brought to position B along arrow R as shown in FIG. 4B. Here, pinion 46 engages rack 42. Then, with drill chuck 14 rotating for drilling, lever 38 may be brought to position C by continuing movement of lever 38 along arrow R. Pivotable movement of lever 38 in the direction of arrow R about pin 40 to position C results in rotation of pinion 46 in the direction of arrow S. Because pinion 46 is meshed with rack 42, rack 42 as well as first member 50 moves further in a linear upward direction of arrow T with upward drilling force F. In this way, actuator 34 provides an upward drilling force to drill chuck 14 and drill bit 26. By rotating lever 38 in a direction opposite of arrow R, drill bit 26 may be withdrawn from work piece W.

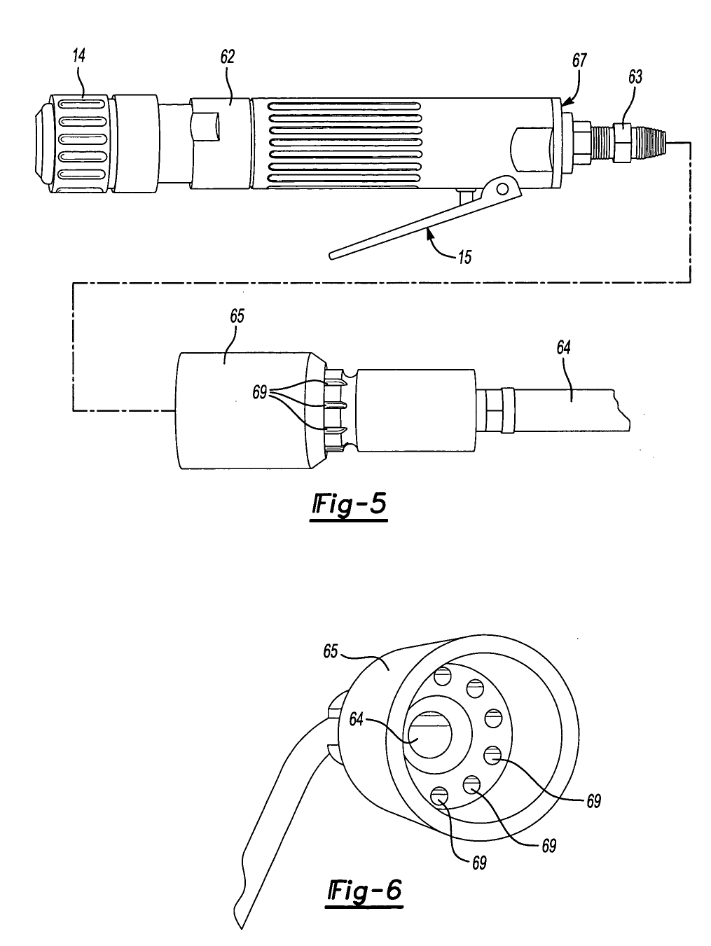

FIGS. 5 and 6 illustrate a close-up view of drive mechanism 62. As shown in FIG. 5, drive mechanism 62 comprises a pneumatic drive mechanism, which is commercially available, having drill chuck 14 and trigger 15. Drill drive mechanism 62 has air inlet 63 to receive air from compressor C. Sleeve 65 couples drill drive mechanism 62 to compressor hose 64. Sleeve 65 fits over air inlet 63 and permits the communication of air from compressor C through compressor hose 64 to air inlet 63. When trigger 15 is pressed, air passes through drill drive mechanism 62 to rotate drill chuck 14. Exhaust air exits out of ports 67 as known and passes through sleeve 65 out of exhaust ports 69. FIG. 6 illustrates exhaust ports 69 as seen from inside sleeve 65.

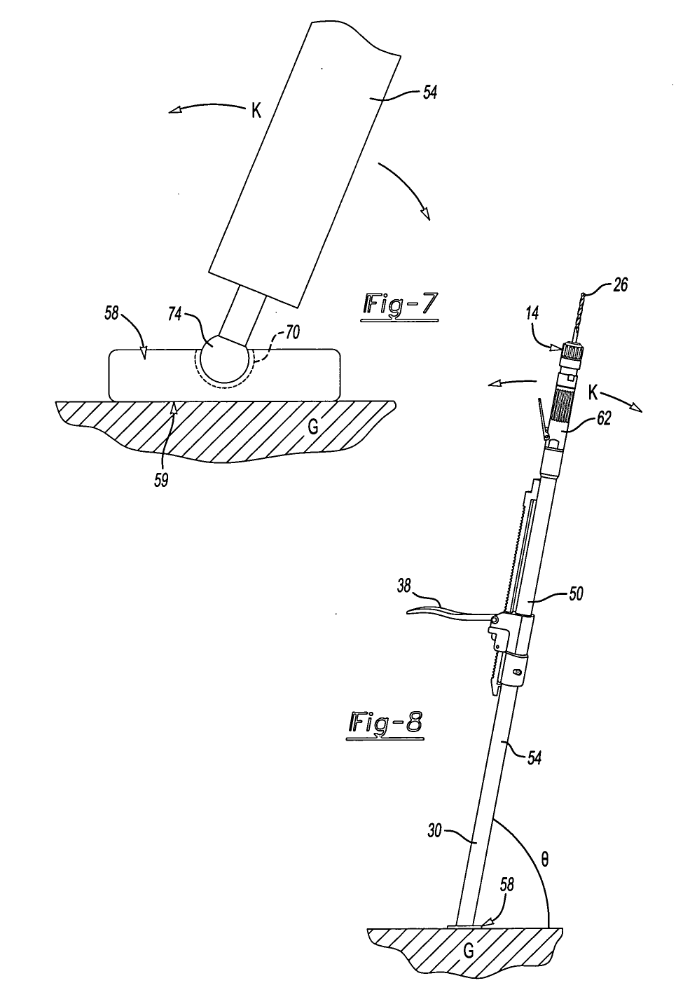

As shown in FIGS. 1 and 2, drill press assembly 10 has foot 58, which is pivotally mounted to second member 54. As shown in FIG. 1 and FIG. 7, foot 58 has socket 70 to receive ball 74, which is attached to second member 54. Foot 58 provides a pivoting surface that allows second member 54 and consequently first member 50 to pivot relative to foot 58 along arrow K so that stand 30 may maintain a sure footing on ground G at various angles. Foot 58 may have rubber gripping surface 59 to prevent foot 58 from sliding on ground G. As shown in FIG. 8, foot 58 allows stand 30 to pivot relative to ground G along arc K at any, say angle θ, while still maintaining a sure footing. In this way, drill press assembly 10 may drill at a variety of angles relative to ground G.

In addition, as shown in FIG. 1, stand 30 is provided with legs 78, which are foldable in the direction of arrow K and extendable in the direction of arrow L. Legs 78 merely allow stand 30 to maintain an upright position when not in use and are not necessarily needed to provide support for drill press assembly 10 in operation.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

1. A drill press assembly comprising:
a drill chuck having an opening to receive a drill bit and a bottom spaced from said opening for supporting said drill bit, said opening elevated above said bottom;
an extendable stand for elevating said drill chuck, said stand extendable between a first height and a second height higher than said first height relative to ground; and
an actuator for creating an upward force to said drill chuck.

2. The drill press assembly of claim 1 wherein said actuator comprises a lever.

3. The drill press assembly of claim 1 wherein said actuator comprises a rack and a pinion.

4. The drill press assembly of Clam 1 wherein said stand comprises a first member and a second member, said first member extendable relative to said second member.

5. The drill press assembly of claim 4 wherein said first member is received in said second member.

6. The drill press assembly of claim 1 wherein said stand has a foot pivotable relative to said stand.

7. The drill press assembly of claim 1 including a drill drive mechanism for rotating said drill chuck.

8. The drill press assembly of claim 1 wherein said drill drive mechanism comprises a pneumatic drill.

9. The drill press assembly of claim 1 including a drill bit received in said drill chuck.

10. A drill press assembly comprising:
a drill chuck;
a brace for supporting said drill chuck, said brace having a retracted length and an extended length greater than said retracted length; and
an actuator for applying an upward force relative to the ground to said drill chuck.

11. The drill press assembly of claim 10 wherein said retracted length has a lower elevation than said extended length.

12. The drill press assembly of claim 10 wherein said actuator comprises a lever.

13. The drill press assembly of claim 12 wherein said lever comprises a rack and pinion.

14. The drill press assembly of claim 10 wherein said brace comprises a first member and a second member, said first member receivable in said second member.

15. The drill press assembly of claim 10 wherein said brace has a foot pivotable relative to said brace.

16. The drill press assembly of claim 10 including a drill drive mechanism for rotating said drill chuck.

17. The drill press assembly of claim 16 wherein said drill drive mechanism comprises a pneumatic drive.

18. The drill press assembly of claim 10 wherein said drill chuck has an opening to receive a drill bit and a bottom spaced from said opening for supporting said drill bit, said opening at a higher elevation than said bottom.

19. A method of drilling comprising the steps of:
supporting a drill bit from a mechanical ground support;
orienting a drill bit to drill in an upward direction from ground along an axis;
elevating the drill bit through the mechanical ground support along the axis from a lower elevation to a higher elevation relative to ground; and
rotating the drill bit about the axis.

20. The method of drilling of claim 19 wherein elevating comprises extending the mechanical ground support from a first height to a second height higher than the first height relative to ground.
